(19) United States
(12) Patent Application Publication
(10) Pub. No.: US 2015/0305109 A1
(43) Pub. Date: Oct. 22, 2015

(54) LED DRIVER AND ILLUMINATION APPARATUS

(71) Applicant: SAMSUNG ELECTRONICS CO., LTD., Suwon-si (KR)

(72) Inventors: Bong Jin LEE, Hwaseong-si (KR); Hyun Jung KIM, Yongin-si (KR)

(21) Appl. No.: 14/602,147

(22) Filed: Jan. 21, 2015

(30) Foreign Application Priority Data
Apr. 17, 2014 (KR) 10-2014-0046138

(51) Int. Cl. H05B 33/08

(52) U.S. Cl. CPC H05B 33/0851; H05B 33/0815

(57) ABSTRACT

An LED driver may include an LED driving unit includes a substrate and a driving circuit provided with the substrate that includes one or more detecting resistors. A controller is configured to control an operation of the LED driving unit, based on a voltage detected by the one or more detecting resistors. The detecting resistors may include first and second conductive wire patterns disposed on a first surface of the substrate and a second surface opposing the first surface, respectively, and one or more conductive vias electrically connect the first and second conductive wire patterns.

### CROSS-REFERENCE TO RELATED APPLICATION

This application claims benefit of priority under 35 U.S.C. §119 to Korean Patent Application No. 10-2014-0046138, filed on Apr. 17, 2014, with the Korean Intellectual Property Office, the entire content of which is incorporated herein by reference.

### TECHNICAL FIELD

The present inventive concept relates to a light emitting device (LED) driver and an illumination apparatus.

### BACKGROUND

Semiconductor light emitting devices have been widely used as light sources due to several advantages thereof, such as low power consumption, high degrees of brightness, and other advantageous features. In particular, recent semiconductor light emitting devices have been employed as backlight units for illumination apparatuses, large scale liquid crystal displays (LCD), and other light sources. In accordance with such applications to various technical areas and various apparatuses, research into driving apparatuses for driving semiconductor light emitting devices has been actively undertaken.

### SUMMARY

One or more aspects of the present inventive concept may provide an LED driver capable of reducing a heating problem and being advantageous for miniaturization.

One or more aspects of the present inventive concept may provide an illumination apparatus including the LED driver.

One or more aspects of the present inventive concept relates to a light emitting device (LED) driver including an LED driving unit that includes a substrate and a driving circuit provided with the substrate and including at least one detecting resistor, and a controller. The controller is configured to control an operation of the LED driving unit, based on a level of a voltage detected by the at least one detecting resistor. The at least one detecting resistor may include first and second conductive wire patterns disposed on a first surface of the substrate and a second surface opposing the first surface, respectively, and at least one conductive via electrically connecting the first and second conductive wire patterns.

The first and second conductive wire patterns and the at least one conductive via may be formed using a material having a specific resistance value of 0.03 Ω·mm²/m or lower at 20° C.

In this case, the conductive via may be formed using at least one of aluminum (Al), copper (Cu), gold (Au), silver (Ag), or alloys thereof.

The first and second conductive wire patterns may include a plurality of first and second conductive wire patterns and the conductive via may include a plurality of conductive vias.

The plurality of conductive vias may be respectively connected to the first conductive wire pattern formed on the first surface and to the second conductive wire pattern formed on the second surface.

In another exemplary embodiment of the present inventive concept, at least one of the plurality of conductive vias may be connected to two or more first conductive wire patterns on the first surface.

The plurality of conductive vias may be arranged in arrays including rows and columns.

Intervals between the plurality of conductive vias may be substantially the one another

In the case of the plurality of conductive vias, at least a portion of intervals therebetween may have a different size to those of the remainder.

The plurality of conductive vias may include two or more conductive vias having different cross sectional areas.

The LED driving unit may further include a circuit pattern provided with the substrate and electrically connecting circuit devices included in the driving circuit to one another.

In this case, the circuit pattern may further include an internal circuit pattern disposed in an internal portion of the substrate.

The detecting resistor may further include a third conductive wire pattern disposed in an internal portion of the substrate and at least one internal conducive via electrically connecting the third conductive wire pattern to at least one of the first and second conductive wire patterns.

The driving circuit may further include a direct current (DC) to DC converter having a switching device, and the controller is configured to control a duty cycle of the switching device.

One or more other aspects of the present inventive concept relates to an illumination apparatus including a light source unit including at least one LED and an LED driver. The LED driver includes a substrate and a driving circuit provided with the substrate that includes at least one detecting resistor. The driving circuit provides driving power to the at least one LED. A controller is configured to control an operation of the LED driving unit, based on a voltage detected by the at least one detecting resistor. The at least one detecting resistor may include first and second conductive wire patterns disposed on a first surface of the substrate and a second surface opposing the first surface, respectively, and at least one conductive via electrically connecting the first and second conductive wire patterns.

One or more other aspects of the present inventive concept relates to an illumination apparatus including a light source unit including at least one LED, an LED driving unit, and a controller. The light source unit includes at least one LED. The LED driving unit is configured to provide driving power to the at least one LED. The LED driving unit includes a substrate and a driving circuit provided in the substrate and including an array of detecting resistors. The controller is configured to control an operation of the LED driving unit, based on a voltage detected by the array of detecting resistors. The array of detecting resistors includes a plurality vias passing through the substrate, and a first conductive wire pattern and a second conductive pattern disposed on a top surface and a bottom surface of the substrate and electrically connecting the plurality of vias.

In another aspect, the substrate includes a wiring layer between the top surface and the bottom surface of the substrate and the wiring layer has a third conductive wire pattern. The array of detecting resistors may further include an internal via disposed between the wiring layer and either of the bottom surface and the top surface. The third conductive pattern connects the internal via with the plurality of vias. In one or more implementations, the plurality of vias may have different widths from one another or the plurality of vias may have the same width.

### BRIEF DESCRIPTION OF DRAWINGS

The above and other aspects, features and other advantages of the present inventive concept will be more clearly understood from the following detailed description taken in conjunction with the accompanying drawings, in which like reference characters may refer to the same or similar parts throughout the different views. The drawings are not necessarily to scale, emphasis instead being placed upon illustrating the principles of the embodiments of the present inventive concept. In the drawings, the thickness of layers and regions may be exaggerated for clarity.

FIG. 1 is a block diagram of an LED driver and an illumination apparatus according to an exemplary embodiment of the present inventive concept;

FIGS. 2A to 2C are views illustrating detecting resistors according to an exemplary embodiment of the present inventive concept;

FIGS. 3A to 5B illustrate modified examples of the embodiments of FIGS. 2A and 2B;

FIGS. 6 to 8 are cutaway cross-sectional views of a region of the substrate in which detecting resistors are formed and illustrate detecting resistors according to an exemplary embodiment of the present inventive concept;

FIGS. 9 to 13 are circuit diagrams of an LED driver and an illumination apparatus using the same according to an exemplary embodiment of the present inventive concept;

FIGS. 14 and 15 are exploded perspective views illustrating an illumination apparatus according to an exemplary embodiment of the present inventive concept by way of example;

FIGS. 16 and 17 are cross-sectional views illustrating examples of an illumination apparatus according to an exemplary embodiment of the present inventive concept, applied to a backlight unit; and

FIG. 18 is a cross-sectional view illustrating an example in which an illumination apparatus according to an exemplary embodiment of the present inventive concept is applied to vehicle headlights.

### DETAILED DESCRIPTION

Exemplary embodiments of the present inventive concept will now be described in detail with reference to the accompanying drawings.

The inventive concept may, however, be exemplified in many different forms and should not be construed as being limited to the specific embodiments set forth herein. Rather, these embodiments are provided so that this inventive concept will be thorough and complete, and will fully convey the scope of the inventive concept to those skilled in the art.

In the drawings, the shapes and dimensions of elements may be exaggerated for clarity, and the same reference numerals will be used throughout to designate the same or like elements. Further, in the present inventive concept, the terms ‘on’, ‘upper part(portion)’, ‘upper surface’, ‘lower’, ‘lower part(portion)’, ‘lower surface’, ‘side (surface)’, and the like, are used based on the drawings. Therefore, actual positions may be changed depending on a direction in which a semiconductor device is actually disposed.

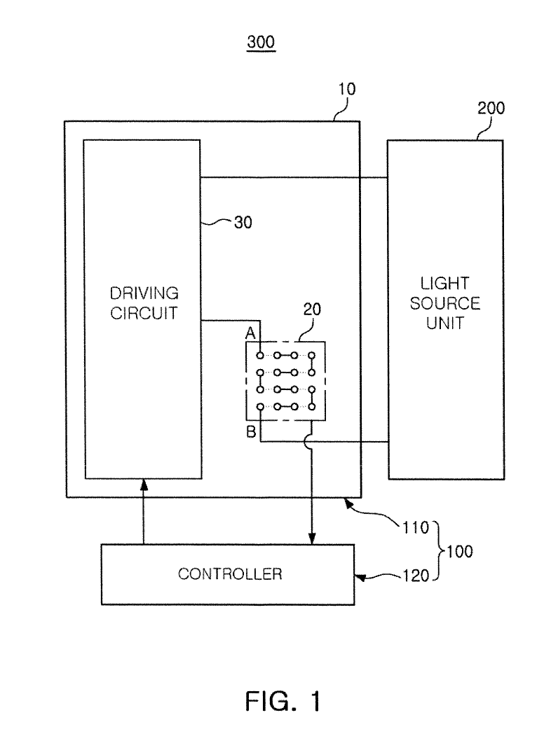

FIG. 1 is a block diagram of an LED driver 100 and an illumination apparatus 300 according to an exemplary embodiment of the present inventive concept.

With reference to FIG. 1, the illumination apparatus 300 according to an exemplary embodiment of the present inventive concept may include a light source unit 200 and an LED driver 100.

The light source unit 200 may include at least one LED receiving driving power from the LED driver 100 and emitting light.

According to the exemplary embodiment of the present inventive concept, the LED driver 100 may include an LED driving unit 110 and a controller 120 configured to control an operation of the LED driving unit 110.

The LED driving unit 110 may include a substrate 10 and a driving circuit 30 provided with the substrate 10. The driving circuit 30 may include circuit devices providing driving power suitable for the light source unit 200. The circuit devices may include, for example, a switching device, a capacitor, an inductor, a diode for current rectification, and the like. The circuit devices may be disposed on the substrate 10 and be electrically connected to one another through a circuit pattern formed on the substrate 10 to perform a predetermined function. Examples of the predetermined function includes a rectifying function for rectifying an external power or a DC-to-DC converting function for changing the magnitude of a direct current power. In one or more aspects, the substrate 10 may be a printed circuit board (PCB) having a circuit pattern printed on an upper part thereof or in an internal portion thereof. The substrate 10 may be formed using a material, for example, FR-4, CEM-3, or other material, but is not limited thereto. In addition, the circuit pattern may contain a conductive metal such as copper (Cu), aluminum (Al), gold (Au), silver (Ag), or another conductive metal.

On the other hand, in the case of using an LED, driven by direct current power, as a light source, in order to control proper brightness, precision control is required to provide a constant current for the LED. For example, when a level of current flowing in the light source unit 200 deviates from a level within a predetermined range, an operation of the LED driving unit 110 needs to be controlled so as to reduce the current level. To the contrary, when a level of current flowing in the light source unit 200 does not reach a level within a predetermined range, the operation of the LED driving unit 110 needs to be controlled to increase the current level.

To this end, the LED driving unit 110 according to the exemplary embodiment of the present inventive concept may include at least one detecting resistor 20 disposed on the substrate 10. The detecting resistor 20 may generate a potential difference so as to allow for detection of current from a portion of the driving circuit 30 the current of which is required to be detected. The controller 120 may thus control an operation of the LED driving unit 110, based on a voltage detected by the detecting resistor 20, for example, a potential difference between both ends A and B of the detecting resistor 20.

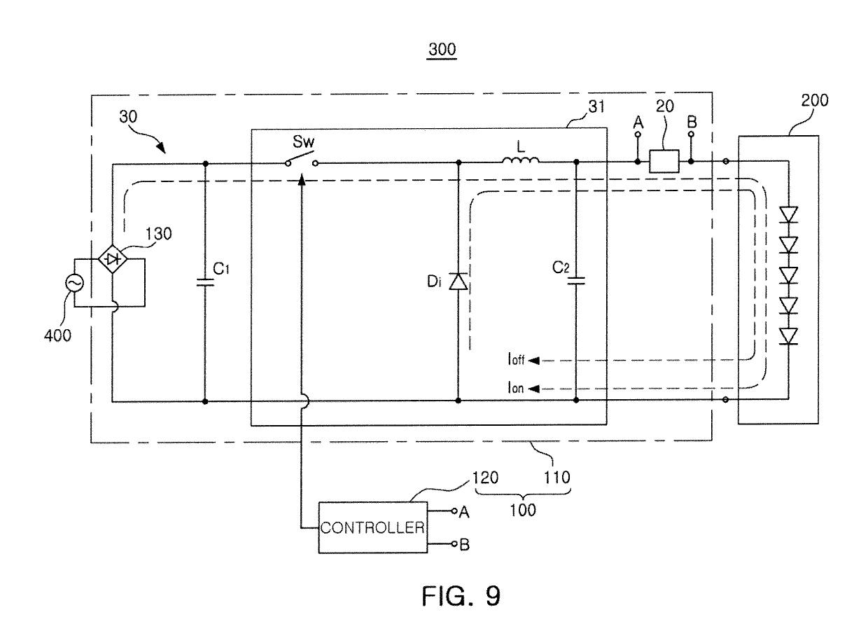

The controller 120 will be described later in detail with reference to FIGS. 9 to 13, and the detecting resistor 20 will first be described below in detail.

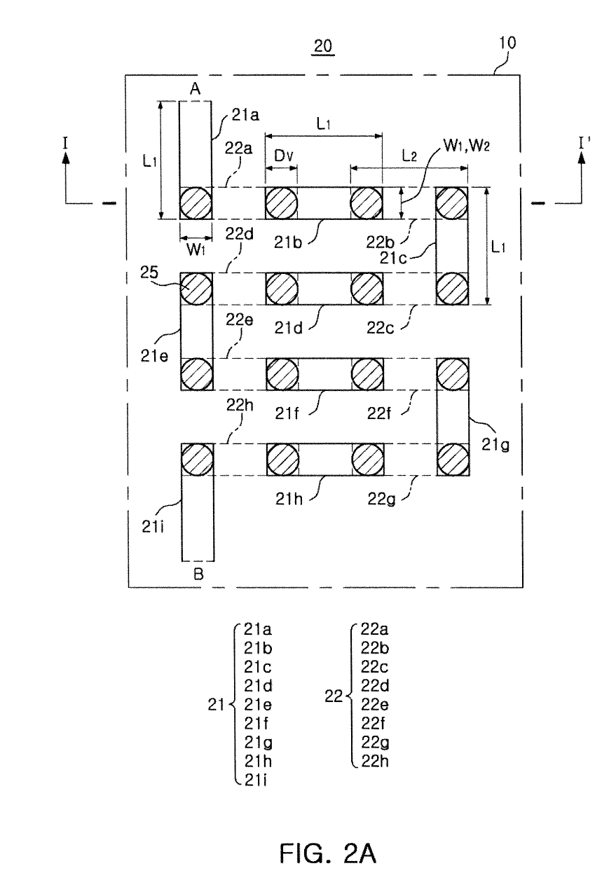

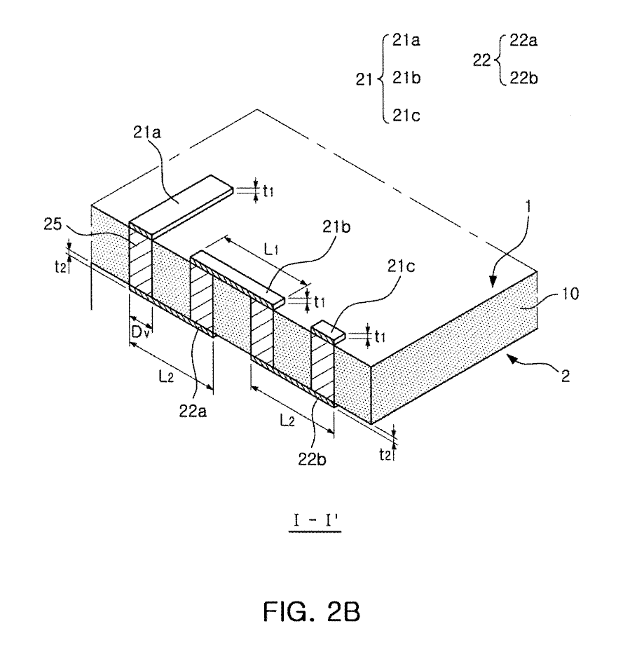

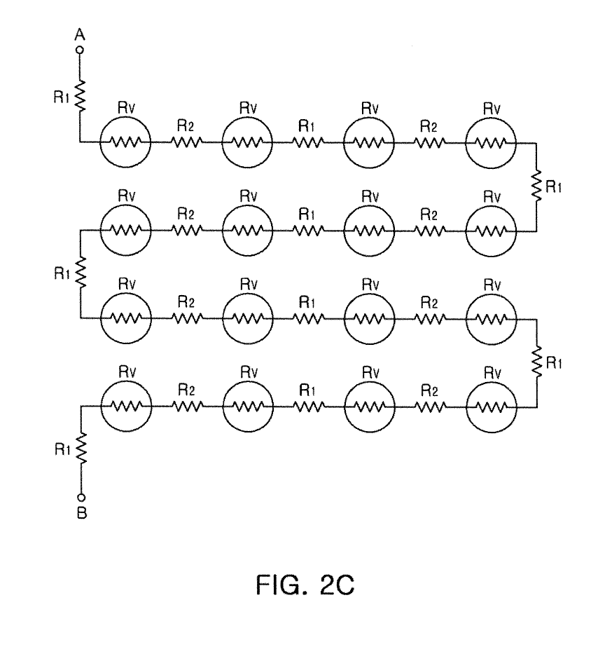

FIGS. 2A to 2C illustrate the detecting resistor 20 according to the exemplary embodiment of the present inventive concept.

In detail, FIG. 2A is a plan view of the detecting resistor 20 disposed on the substrate 10, and FIG. 2b is a cutaway perspective view of line I-I′ of FIG. 2A. FIG. 2C is an equivalent circuit diagram of the detecting resistor 20 of FIG. 2A illustrating a resistance value of the detecting resistor 20 according to the exemplary embodiment of the present inventive concept.

With reference to FIGS. 2A and 2B, the detecting resistor 20 according to the exemplary embodiment of the present inventive concept may include first and second conductive wire patterns 21 and 22 disposed on a first surface 1 of the substrate 10 and a second surface 2 opposing the first surface 1, respectively, and at least one conductive via 25 electrically connecting the first and second conductive wire patterns 21 and 22.

The first and second conductive wire patterns 21 and 22 may be formed using a portion of the circuit pattern formed on the substrate 10, but are not limited thereto. In this case, the first and second conductive wire patterns 21 and 22 may contain the same material as that of the circuit pattern, for example, a metal such as Cu, Al, Au, or Ag.

FIGS. 2A and 2B illustrate the case that the first conductive wire patterns 21 (for example, nine patterns 21a to 21i) may have the same thickness t₁, width W₁ and length L₁ as one another, but are not limited thereto. Similar thereto, as illustrated in FIGS. 2A and 2B, the second conductive wire patterns 22 (for example, eight patterns 22a to 22h) may have the same thickness t₂, width W₂ and length L₁ as one another. In addition, the plurality of first and second conductive wire patterns 21a to 21i and 22a to 22h may have the same thickness (t₁, t₂), width (W₁, W₂) and length (L₁, L₂) as one another, but are not limited thereto.

The conductive via 25 may penetrate through at least a portion of the substrate 10 between the first surface 1 and the second surface 2 of the substrate 10, and may electrically connect the first and second conductive wire patterns 21 and 22 to one another. The conductive via 25 may be formed using an electrical conductive material of which a specific resistance value exceeds 0 Ω·mm²/m at 20° C. but is less than 0.03 Ω·mm²/m, and for example, may contain at least one of aluminum (Al), copper (Cu), gold (Au), silver (Ag), and alloys thereof, but is not limited thereto. The conductive via 25 may be formed using the same material as those of the first and second conductive wire patterns 21 and 22, but is not limited thereto, for example, may be formed using a material different therefrom. For example, the first and second conductive wire patterns 21 and 22 may be formed using Cu, while the conductive via 25 may be formed using Al. For reference, the specific resistance values of Cu and Al correspond to about 0.01785 Ω·mm²/m and 0.02774 Ω·mm²/m at 20° C., respectively.

According to an exemplary embodiment of the present inventive concept, the conductive via 25 may be provided in plural, and the plurality of conductive vias may be arranged in an array including rows and columns as viewed from above the first surface 1 of the substrate 10. For example, with reference to FIGS. 2A and 2B, the conductive vias 25 may be provided as 16 conductive vias, and may be arranged in a 4×4 array including four rows and four columns with similar intervals therebetween as viewed from above the first surface 1, but are not limited thereto. For example, the conductive vias 25 may be disposed to be distributed as viewed from above the substrate 10. Further, the plurality of conductive vias 25 may have similar cross-sectional shapes and lengths, one another as illustrated in the drawing, but are not limited thereto.

In the exemplary embodiment of the present inventive concept, a resistance value of the detecting resistor 20, in detail, a resistance value from one end A of the detecting resistor 20 to the other end B thereof may be determined by the first and second conductive wire patterns 21 and 22 and the conductive vias 25.

In detail, in the exemplary embodiment of the present inventive concept, when a specific resistance value of a material forming the first conductive wire pattern 21, a thickness of the first conductive wire pattern 21, a width thereof and a length thereof are defined as ρ₁, t₁, W₁, and L₁, respectively, a resistance value R₁ of one first conductive wire pattern 21 may be calculated by using

$${R}_{1} = {ρ}_{1} \frac{{L}_{1}}{{t}_{1} \cdot {W}_{1}} .$$

Similarly, when a specific resistance value of a material forming the second conductive wire pattern 22, a thickness of the second conductive wire pattern 22, a width thereof and a length thereof are defined as ρ₂, t₂, W₂, L₂, respectively, a resistance value R₂ of one second conductive wire pattern 22 may be calculated by using

$${R}_{2} = {ρ}_{2} \frac{{L}_{2}}{{t}_{2} \cdot {W}_{2}} .$$

In addition, a resistance value Rᵥ of one conductive via 25 may be calculated by a specific resistance value ρᵥ of a material forming the conductive via 25, a cross section and a length thereof. For example, in the case that the conductive via 25 has a cylindrical shape, when a diameter of a cylinder is Dᵥ and a length thereof is tᵥ, a resistance value may be calculated by using

$${R}_{v} = {ρ}_{v} \frac{4 {t}_{v}}{π \cdot {D}_{v}^{2} } .$$

Therefore, as illustrated in FIGS. 2A and 2B, in a case in which the plurality of conductive vias 25 are connected to a single first conductive wire pattern 21 on the first surface 1 and are connected to a single second conductive wire pattern 22 on the second surface 2, the plurality of conductive vias 25 may be connected to _one another in series via resistance components thereof. This may be expressed as an equivalent circuit, for example, a circuit diagram of FIG. 2C. In detail, a resistance value from one end A of the detecting resistor 20 to the other end B thereof may be represented by R_{T}=9R₁+R₂+16Rᵥ.

The resistance value Rₜ of the detecting resistor 20 may be designed to be equal to or less than 200 mΩ, such that detection of a current detected from the driving circuit by the detecting resistor 20 may be easily performed in a position of the detecting resistor 20. In this case, the number, thicknesses t₁ and t₂, widths W₁ and W₂ and lengths L₁ and L₂ of the first and second conductive wire patterns 21 and 22, and the number of the conductive vias 25, a cross sectional area thereof, and a length tᵥ thereof may be properly designed. When the conductive via 25 has a cylindrical shape, a cross sectional area of the conductive via may be changed by properly selecting a diameter Dᵥ.

According to the exemplary embodiment of the present inventive concept, in implementing the detecting resistor 20 in the LED driving unit 110, the miniaturized LED driver 100 may be obtained without a separate resistor, a resistant material, or the like. In addition, since the conductive via 25 according to the exemplary embodiment of the present inventive concept is formed using a material that has a resistance value equal to or less than 0.03 Ω·mm²/m at 20° C., a resistance value of one conductive via 25 is relatively low such that a heating problem may be significantly reduced. Further, a plurality of conductive vias 25 are disposed to be distributed so as to obtain effective heat dispersion. In this case, because variations in a specific resistance value that depends on a change in temperature are not that large, more precise current detection may be performed.

In addition, the exemplary embodiment of the present inventive concept provides the case that the plurality of conductive wire patterns 21 and 22 have the same thickness (t₁, t₂), width (W₁, W₂) and length (L₁, L₂) as one another and the plurality of conductive vias 25 have the same cross-sectional area and length tᵥ as one another, and may be variously changed, according to process and/or design changes thereof, as needed.

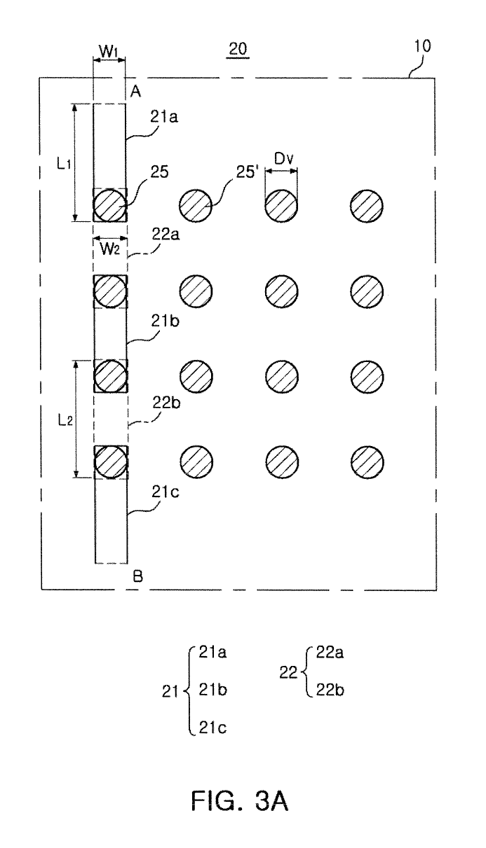

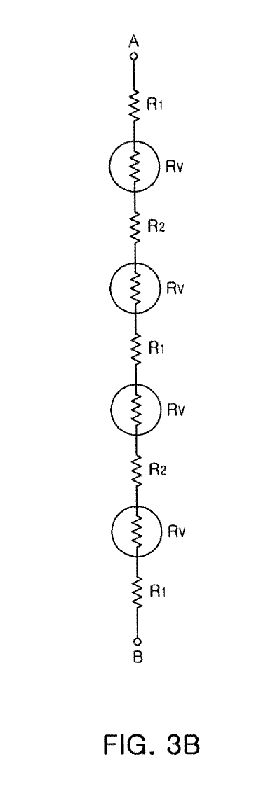

FIGS. 3A and 3B illustrate modified examples of FIGS. 2A and 2B. In detail, FIG. 3A is a plan view of the detecting resistor 20 disposed on the substrate 10. FIG. 3B is an equivalent circuit diagram of the detecting resistor 20 illustrating a resistance value of the detecting resistor 20 according to the exemplary embodiment of the present inventive concept.

The detecting resistor 20 may include first and second conducive patterns 21 and 22 having various connection structures according to a resistance value to be provided by the detecting resistor 20 as illustrated in FIG. 3A. In detail, when the resistance value to be provided by the detecting resistor 20 is relatively low, a portion of conductive vias 25, among the plurality of conductive vias 25 and 25′, formed in the substrate 10 is connected to one another by the first and second conductive patterns 21 and 22. According to the exemplary embodiment of the present inventive concept, the detecting resistor 20 may include three first conductive wire patterns 21a to 21c, two second conductive wire patterns 22a and 22b, and four conductive vias 25. Here, when a resistance value R_{T} of the detecting resistor 20 is represented through an equivalent circuit, the resistance value may be calculated by R_{T}=3R₁+2R, +4Rᵥ. In this case, the first and second conductive wire patterns 21 and 22, and conductive vias 25′, not connected to other circuit devices included in the driving circuit, may remain as a conductive via dummy in the substrate 10.

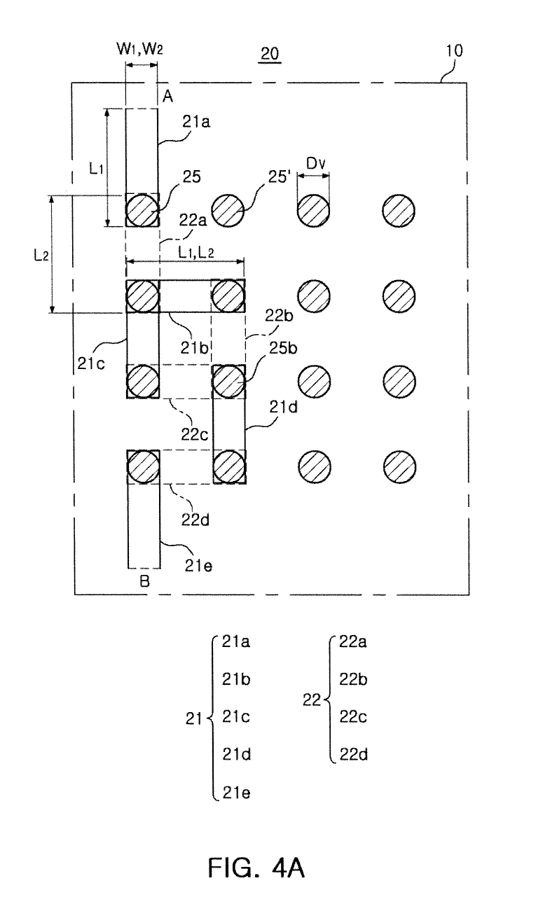

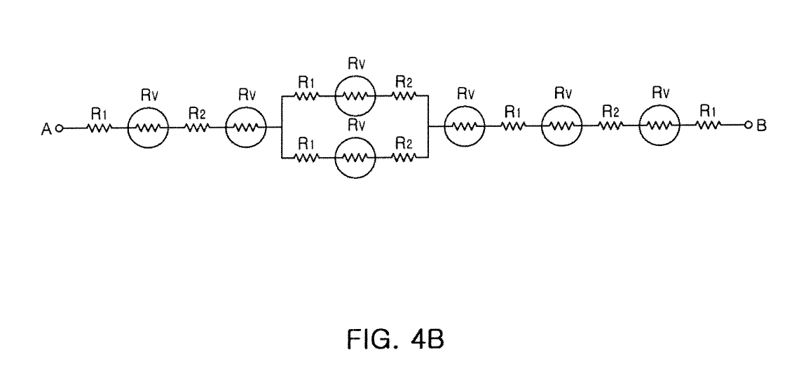

FIGS. 4A and 4B illustrate modified examples of FIGS. 2A and 2B. FIG. 4A is a plan view of the detecting resistor 20 disposed on the substrate 10, and FIG. 4B is a circuit diagram illustrating an equivalent circuit of the detecting resistor 20 and illustrate a resistance value of the detecting resistor 20 according to the exemplary embodiment of the present inventive concept.

In the exemplary embodiment of the present inventive concept, at least one of the plurality of conductive vias 25 may be connected to two or more of the first conductive wire patterns 21 on the first surface 1. In addition, at least one of the plurality of conductive vias 25 may be connected to two or more of the second conductive wire patterns 22 on the second surface 2. For example, with reference to FIG. 4A, the plurality of conductive vias may respectively include one conductive via 25a connected to two or more of the first conductive wire pattern 21b and 21c and one conductive via 25b connected to two or more of the second conductive wire patterns 22b and 22c. In this case, it can be understood that at least portions of the plurality of conductive vias 25 may be connected to one another in parallel via at least portions of resistance components thereof. In detail, when the detecting resistor 20 according to the exemplary embodiment of the present inventive concept is represented through an equivalent circuit, it can be depicted as illustrated in the circuit diagram of FIG. 4B. A resistance value R_{T} from one end A of the detecting resistor 20 to the other end B thereof may be calculated by R_{T}=3.5R₁+2.5R₂+5.5Rᵥ.

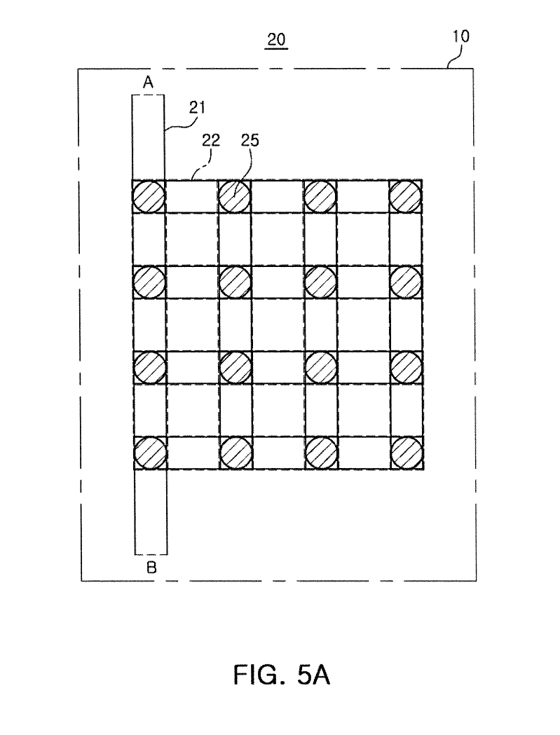

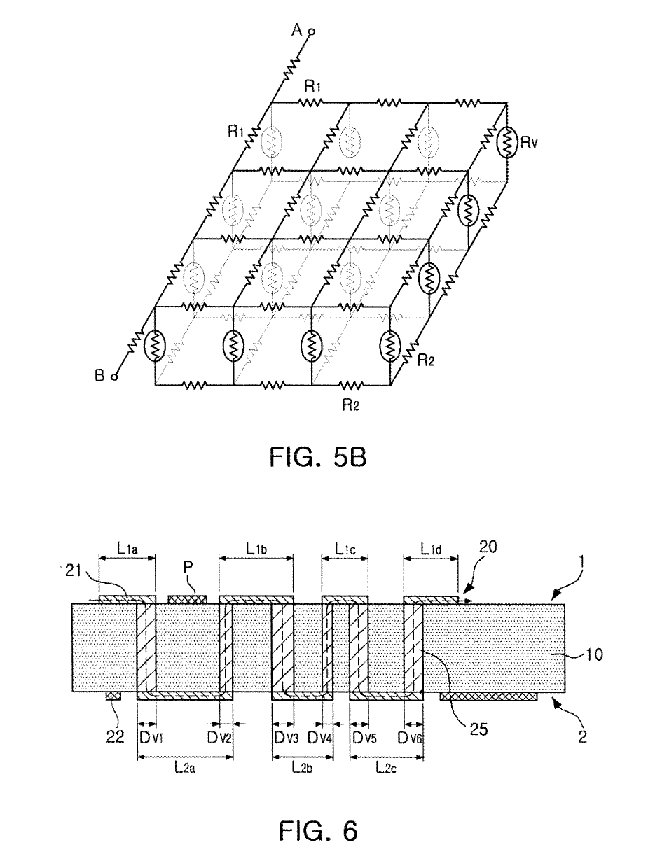

The detecting resistor 20 may have various resistance values according to a connection type of the plurality of conductive vias 25 and the first and second conductive wire patterns 21 and 22. In some aspects, all of the plurality of conductive vias 25 may be connected in parallel via resistance components thereof, as illustrated in FIG. 5A. In this case, the equivalent circuit of the detecting resistor 20 according to an exemplary embodiment of the present inventive concept with respect to FIG. 5A can be depicted as illustrated in FIG. 5B. The connection type between such conductive vias 25 and the first and second conductive wire patterns 21 and 22 may be variously changed according to a resistance value to be provided by the detecting resistor 20.

FIG. 6 illustrates a detecting resistor 20 included in an LED driving unit 110, that may be used in an LED driver 100 according to an exemplary embodiment of the present inventive concept and an illumination apparatus 300 using the same.

In the exemplary embodiment of the present inventive concept, the LED driver 100 may include an LED driving unit 110 including a substrate 10 and a driving circuit 30 disposed on the substrate 10 and containing at least one detecting resistor 20, and a controller 120 controlling an operation of the LED driving unit 110. FIG. 6 is a cross-sectional view of a region of the substrate 10 in which the detecting resistor 20 is disposed. Here, a current path of the detecting resistor 20 is represented with an dotted arrow.

The substrate 10 may be formed using a material, for example, FR-4, CEM-3, or the like, but is not limited thereto. In addition, the circuit patterns P electrically connecting circuit devices provided with the driving circuit 30 may be disposed on the first and second surfaces 1 and 2 of the substrate 10.

With reference to FIG. 6, the detecting resistor 20 may include first and second conductive wire patterns 21 and 22 disposed on a first surface 1 of the substrate 10 and a second surface 2 opposing the first surface 1, respectively, and conductive vias 25 electrically connecting the first and second conductive wire patterns 21 and 22.

In the exemplary embodiment of the present inventive concept, the first and second conductive wire patterns 21 and 22 and the conductive vias 25 may respectively be provided in plural, and at least portions of intervals between the plurality of conductive vias 25 may be different from one another. Thus, the first conductive wire pattern 21 connecting the plurality of conductive vias 25 may have different lengths L₁ₐ, L_{1b}, L_{1c}, and L_{1d}. Similarly, the second conductive wire pattern 22 may have different lengths L₂ₐ, L_{2b}, and L_{2c}.

In addition, in the case of the plurality of conductive vias 25, at least one thereof may have a different cross-sectional area. For example, in a case in which the conductive via 25 has a cylindrical shape, the plurality of conductive vias 25 may have different diameters Dᵥ₁, Dᵥ₂, Dᵥ₃, Dᵥ₄, Dᵥ₅, and Dᵥ₆. Therefore, by properly setting lengths L₁ₐ to L_{1d}, and L₂ₐ to L_{2c} of the first and second conductive wire patterns 21 and 22, cross sectional areas and/or diameters Dᵥ₁ to Dᵥ₆ of the conductive vias 25, and the like, a resistance value to be exhibited by the detecting resistor 20 may be easily implemented.

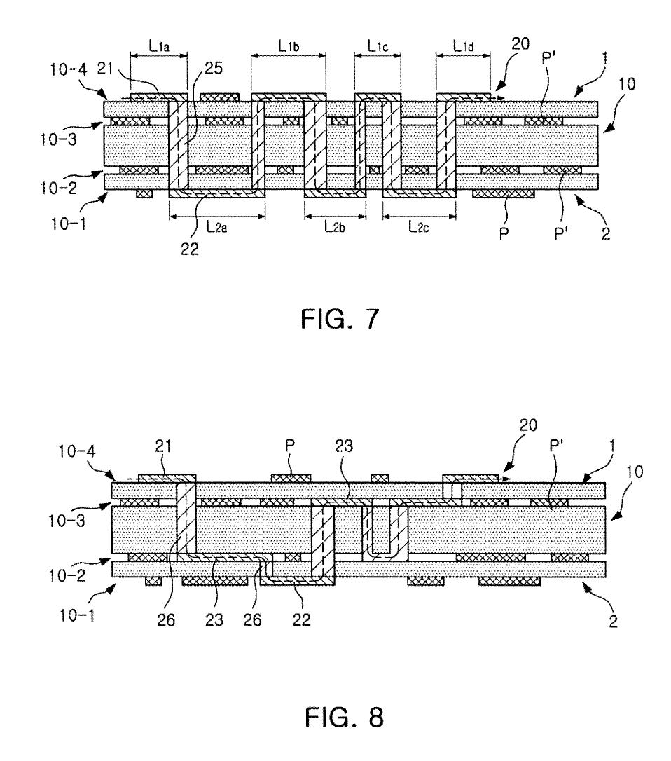

FIG. 7 illustrates a detecting resistor 20 included in an LED driving unit 110, that may be used in an LED driver 100 according to an exemplary embodiment of the present inventive concept and an illumination apparatus 300 using the same.

In the exemplary embodiment of the present inventive concept, the substrate 10 may be a multilayer printed circuit board including a plurality of wiring layers. Although FIG. 7 illustrates the case that the substrate 10 includes four wiring layers 10-1 to 10-4, it may be variously changed as needed. When the wiring layers are defined as first to fourth wiring layers 10-1 to 10-4 from the bottom, the first and second conducting patterns 21 and 22 may be disposed on the first wiring layer 10-1 and the fourth wiring layer 10-4, and circuit patterns P electrically connecting circuit devices included in the driving circuit 30 may be disposed on the second and third wiring layers 10-2 and 10-3, internal wiring layers of the substrate 10. In this case, the substrate 10 may include an internal circuit pattern P′ disposed between a first surface 1 and a second surface 2, by which the circuit pattern P for an electrical connection of circuit devices and a space in which the first and second conductive wire patterns 21 and 22 can be disposed may be secured.

FIG. 8 illustrates a modified example of FIG. 7.

In the exemplary embodiment of the present inventive concept, the substrate 10 may be a multilayer printed circuit board including a plurality of wiring layers. Here, the detecting resistor 20 may further include a third conductive wire pattern 23 disposed on an internal wiring layer, for example, the second wiring layer 10-2 and/or the third wiring layer 10-3.

In detail, the detecting resistor 20 may further include a third conductive wire pattern 23 disposed between a first surface 1 and a second surface 2, and may include an internal conductive via 26 having at least one electrical connection of an electrical connection between the first conductive wire pattern 21 and the third conductive wire pattern 23 and an electrical connection between the second conductive wire pattern 22 and the third conductive wire pattern 23. In this case, the detecting resistor 20 may be implemented using an internal wiring layer other than an external wiring layer formed on the first surface 1 and the second surface 2 of the substrate 10, for example, using an internal wiring layer other than the first wiring layer 10-1 and the fourth wiring layer 10-4. Therefore, a space in which the circuit pattern P can be disposed on the external wiring layer may be secured.

FIGS. 9 to 13 are circuit diagrams of an LED driver 100 according to an exemplary embodiment of the present inventive concept and an illumination apparatus 300 using the same.

With reference to FIG. 9, the illumination apparatus 300 according to an exemplary embodiment of the present inventive concept may include a light source unit 200 containing at least one LED, and an LED driver 100 driving the light source unit 200. The LED driver 100 may include an LED driving unit 110 providing driving power to the at least one LED, and a controller 120 controlling an operation of the LED driving unit 110. The LED driving unit 110 may include a substrate 10 and a driving circuit 30 disposed on the substrate 10 and containing at least one detecting resistor, for which FIG. 9 illustrates the circuit diagram from which the substrate is omitted.

The driving circuit 30 may include a rectifying unit 130 rectifying power from an external power source 400 applied externally, a smoothing capacitor C1 smoothing power rectified by the rectifying unit 130, and a direct current (DC) to DC converter. The rectifying unit 130, the smoothing capacitor C1, and the DC-to-DC converter may implemented by a plurality of circuit devices included in the driving circuit 30.

On the other hand, in the exemplary embodiment of the present inventive concept, the DC-to-DC converter may be a buck converter 31. In this case, the DC-to-DC converter may include a switching device Sw, for example, an FET, an inductor L having one end connected to the switching device Sw, and a diode Di of which a cathode terminal is connected between the switching device Sw and the inductor L. In addition, the DC-to-DC converter, the buck converter 31, may include a capacitor C2 connected to the other end of the inductor L. In the case of the buck converter 31, in the case that the switching device Sw is turned on, the diode Di is turned off so as to form a current path Ion, and a portion of flowing current may be charged into the form of magnetic energy in the inductor L. Then, when the switching device Sw is turned off, the diode Di is turned on and the magnetic energy charged in the inductor L is released as a current and flows in the light source unit 200. Therefore, by controlling a duty cycle of the switching device Sw, a current flowing to an LED included in the light source unit 200 may be controlled. To this end, the LED driver 100 may include a controller 120 controlling an operation of the LED driving unit 110.

The controller 120 may control a duty cycle of the switching device Sw configuring the DC-to-DC converter included in the LED driver 110. In detail, when it is determined that a level of current flowing in the LED is higher than a predetermined level, the controller 120 may reduce a duty cycle of the switching device Sw, and when it is determined that a level of current flowing in the LED is lower than a predetermined level, the controller 120 may increase a duty cycle of the switching device Sw.

The current flowing in the light source unit 200 may be detected using the detecting resistor 20 according to the exemplary embodiment of the present inventive concept, included in the LED driving unit 110. The controller 120 may be connected to both ends A and B of the detecting resistor 20 and may detect a current flowing in the detecting resistor 20, based on a potential difference between both ends A and B, but is not limited thereto.

The detecting resistor 20 may be properly connected to a position necessary for detection of current. For example, the detecting resistor 20 may be connected between an output terminal of the DC-to-DC converter 31 and an input terminal of the light source unit 200, for example, in a portion in which current flowing in the light source unit 200 can be easily measured. However, although it is not particularly limited, the detecting resistor 20 may also be connected between an output terminal of the light source unit 200 and a ground so as to detect a current flowing to the ground through the light source unit 200.

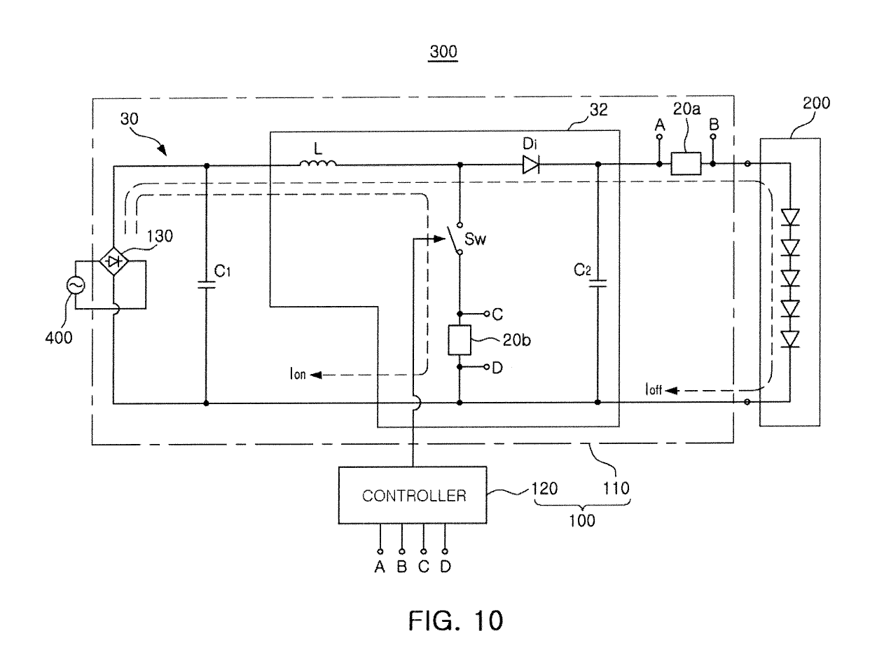

FIG. 10 illustrates an example in which a boost converter 32 is employed as a DC-to-DC converter in the driving circuit 30, in an LED driver 100 and an illumination apparatus 300 according to the exemplary embodiment of the present inventive concept.

Descriptions of portions the same as those of the foregoing exemplary embodiment of the present inventive concept will be omitted, and descriptions of portions different therefrom will be principally described.

In the exemplary embodiment of the present inventive concept, the DC-to-DC converter may be a boost converter 32. In this case, the DC-to-DC converter may include an inductor L and a diode Di of which an anode terminal is connected to one end of the inductor L, and a switching device Sw of which one end is connected to one end of the inductor L and an anode terminal of the diode Di. In addition, the DC-to-DC converter may include a capacitor C2 connected to a cathode terminal of the diode Di.

In the case of the boost converter 32, in the case that the switching device Sw is turned on, the diode Di is turned off so as to form a current path Ion, while a portion of flowing current may be charged into the form of magnetic energy in the inductor L. Then, when the switching device Sw is turned off, the diode Di is turned on and the magnetic energy charged in the inductor L is released as a current and flows in the light source unit 200. In this case, the magnetic energy charged in the inductor L, as well as power applied from the external power source 400, may be released as a current together, so as to operate as a boost converter.

In this case, a current applied to an LED included in the light source unit 200 may be controlled by controlling a duty cycle of the switching device Sw. To this end, the LED driver 100 may include a controller 120 controlling an operation of the LED driving unit 110.

The controller 120 may control a current applied to the light source unit 200 by controlling a duty cycle of the switching device Sw of the DC-to-DC converter 32, based on a potential difference between both ends (at least one of A with B and C with D) of the detecting resistors 20a and 20b included in the LED driving unit 110.

In the exemplary embodiment of the present inventive concept, the detecting resistors 20a and 20b may be properly connected to a position necessary for detection of current. For example, the detecting resistor 20 may be connected between an output terminal of the DC-to-DC converter and an input terminal of the light source unit 200. In this case, the detecting resistor 20a may detect a current directly applied to the light source unit 200 from the LED driver 100. In addition, the detecting resistor 20b may be connected between the other end of the switching device Sw and a ground. In this case, the detecting resistor 20b may detect a current Ion flowing when the switching device Sw is turned on. The controller 120 may control the switching device to be switched off when a level of the current Ion is higher than a predetermined level, and may control the switching device to be switched on when a level of the current Ion is lower than that of a predetermined level.

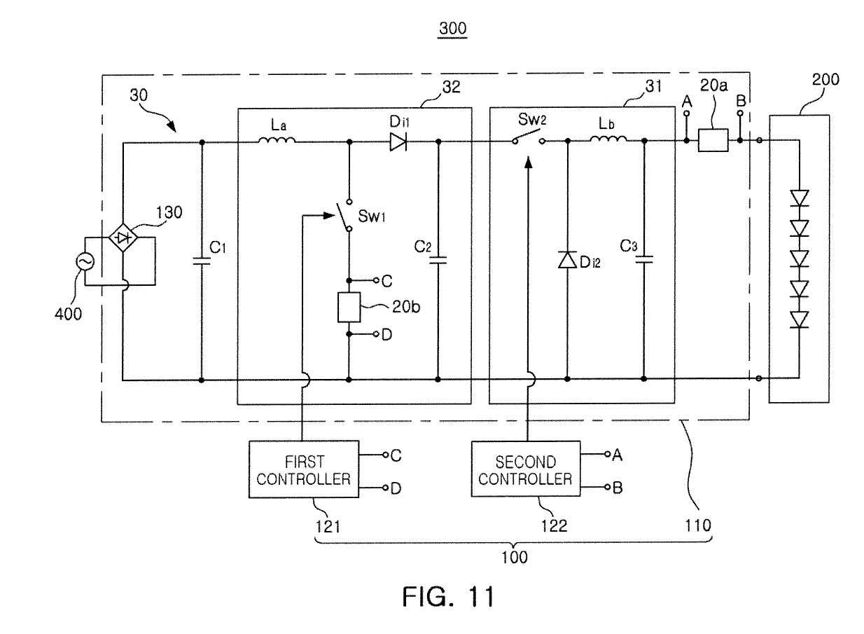

On the other hand, since the buck converter 31 and the boost converter 32 do not need to be exclusively applied within one driving circuit 30, the driving circuit 30 may include both of the buck converter 31 and the boost converter 32, as illustrated in FIG. 11.

The detecting resistors 20a and 20b may be properly connected to a position necessary for detection of current. As illustrated in FIG. 11, two detecting resistors 20b and 20a may be connected between the other end of a switching device Sw1 included in the boost converter 32 and a ground and between an output terminal of the buck converter 31 and an input terminal of the light source unit 200, respectively.

In this case, the controller may include first and second controllers 121 and 122, and the first controller 121 may control a current, based on a potential difference between both ends C and D of the detecting resistor 20b connected between the other end of the switching device Sw1 included in the boost converter 32 and a ground and may control a duty cycle of the switching device Sw1 included in the boost converter 32. The second controller 122 may control a current, based on a potential difference between both ends A and B of the detecting resistor 20a connected between an output terminal of the buck converter 31 and an input terminal of the light source unit 200 and may control a duty cycle of a switching device Sw2 included in the buck converter 31.

However, the present inventive concept is not particularly limited. Therefore, the first and second controllers 121 and 122 may control duty cycles of the switching devices Sw1 and Sw2 in consideration of all of current values detected by two detecting resistors 20a and 20b. In addition, the first and second controllers 121 and 122 may also be implemented as a single controller.

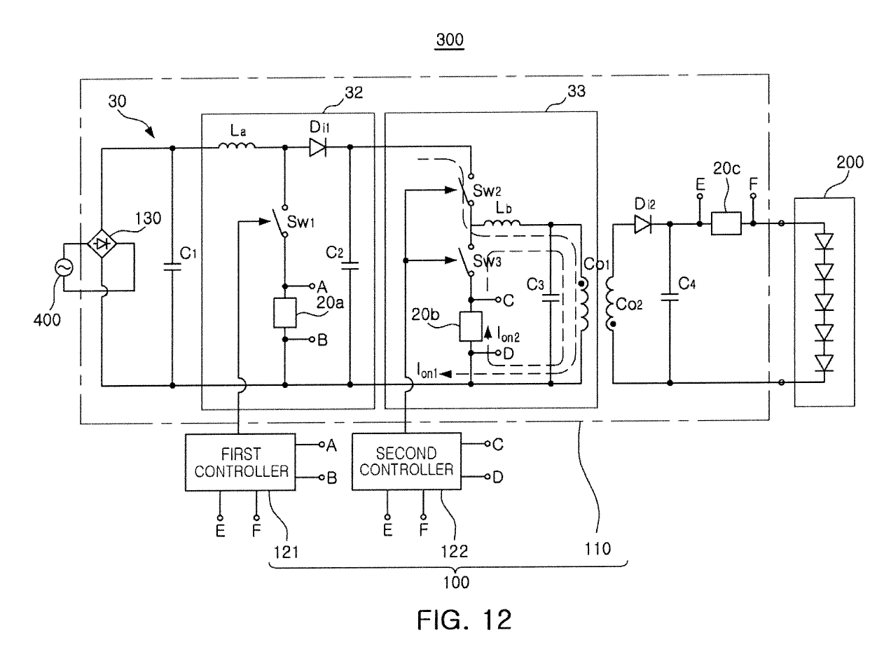

FIG. 12 illustrates an example in which the driving circuit 30 employs a boost/half bridge resonance converter as a DC-to-DC converter in the LED driver 100 and the illumination apparatus 300 according to the exemplary embodiment of the present inventive concept.

With reference to FIG. 12, the DC-to-DC converter according to the exemplary embodiment of the present inventive concept may include a boost converter 32 and a half bridge resonance converter 33. Hereinafter, since the boost converter 32 may be applied equally to the case of the foregoing exemplary embodiment of the present inventive concept, a description thereof will be omitted, and an operational principle of the half bridge resonance converter 33 using a detecting resistor 20b will be described.

The half bridge resonance converter 33 may include first and second switching devices Sw2 and Sw3 whose one ends are connected to one another, and may include a transformer and an inductor Lb, of which one ends are connected between the two switches Sw2 and Sw3. The transformer may include a primary coil Co1 and a secondary coil Co2. The primary coil Co1 of the transformer may be connected to the other end of the inductor Lb, and a capacitor C3 may be connected to the primary coil Co1 in parallel.

The second switching device Sw3 may be controlled so that it is turned off when the first switching device Sw2 is turned on and it is turned on when the first switching device Sw2 is turned off.

When the first switching device Sw2 is turned on and the second switching device Sw3 is turned off, a current path in the half bridge resonance converter 33 may be Ion1, and a portion of flowing current may be charged into the form of magnetic energy in the inductor Lb. Then, when the second switching device Sw3 is turned on and the first switching device Sw2 is turned off, the magnetic energy charged in the inductor Lb may be released as a current to form a current path Ion2. The magnitude of power induced to the secondary coil Co2 of the transformer may be changed depending on a difference in current values between the Ion1 and the Ion2. A current flowing in the light source unit 200 may therefore be controlled by controlling a duty cycle of the first and second switching devices Sw2 and Sw3.

In the exemplary embodiment of the present inventive concept, the detecting resistor 20b may be connected between the other end of the second switching device Sw3 and a ground in the half bridge resonance converter 33 so as to detect Ion2. The second controller 122 may be connected between both ends C and D of the detecting resistor 20b and may detect a current flowing in the detecting resistor 20b, based on a potential difference between both ends C and D of the detecting resistor 20b to control a duty cycle of the first and second switching devices Sw2 and Sw3. For example, when a current value of the detected Ion2 is higher than a predetermined level, the second controller 122 may control the first switching device Sw2 to be switched on and control the second switching device Sw3 to be switched off.

In addition, the second controller 122 may also control duty cycles of the first and second switching devices Sw2 and Sw3 according to a current value detected, based on a potential difference between both ends E and F of the detecting resistor 20c connected between an output terminal of the LED driver 100 and an input terminal of the light source unit 200, and may also control duty cycles of the first and second switching devices Sw2 and Sw3 in consideration of all of current values detected by two detecting resistors 20b and 20c.

Similar to the case of the foregoing exemplary embodiment of the present inventive concept, the first controller 121 may detect a current based on a potential difference between both ends A and B of the detecting resistor 20a connected between the other end of the switching device Sw1 included in the boost converter 32 and a ground and may control a duty cycle of the switching device Sw1 included in the boost converter 32. In addition, the first controller 121 may control also control duty cycles of the first and second switching devices Sw2 and Sw3 according to a current value detected, based on a potential difference between both ends E and F of the detecting resistor 20c connected between an output terminal of the LED driver 100 and an input terminal of the light source unit 200.

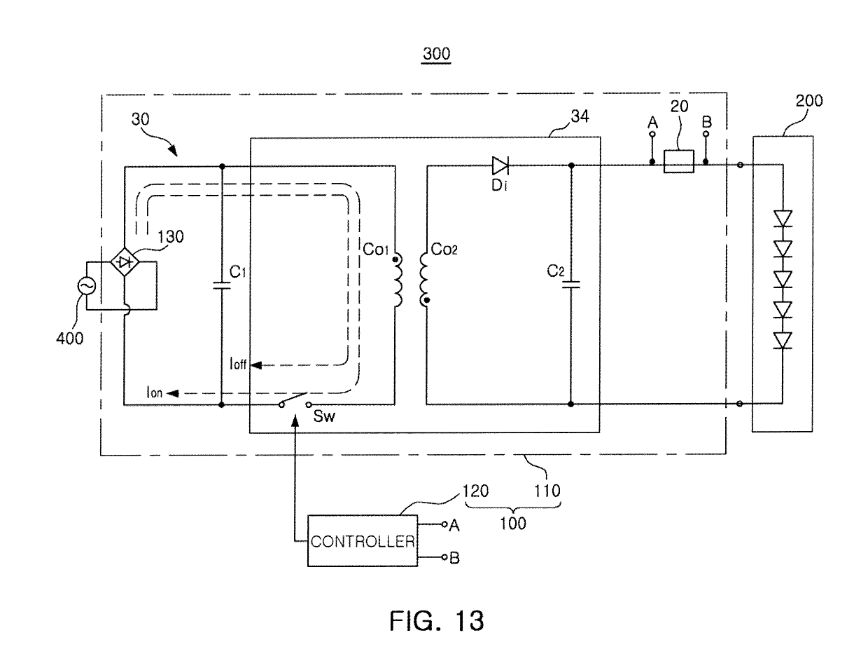

FIG. 13 illustrates an example in which a flyback converter 34 is employed as a DC-to-DC converter in the driving circuit 30, in the LED driver 100 and the illumination apparatus 300 according to the exemplary embodiment of the present inventive concept.

In the exemplary embodiment of the present inventive concept, the flyback converter may include a transformer including a primary coil Co1 and a secondary coil Co2 and a switching device Sw. In cases in which the switching device Sw of the flyback converter 34 is respectively turned on and off, current paths may be Ion and Ioff, respectively, and the magnitude of power induced to the secondary coil Co2 of the transformer may be changed depending a difference in current values of Ion and Ioff. Thus, a current flowing in the light source unit 200 may be controlled by controlling a duty cycle of the switching device Sw.

The detecting resistor 20 may be connected between an output terminal of the LED driver 100 and an input terminal of the light source unit 200, and the controller 120 may control a duty cycle of the switching device Sw according to a current value detected, based on a potential difference between both ends A and B of the detecting resistor 20.

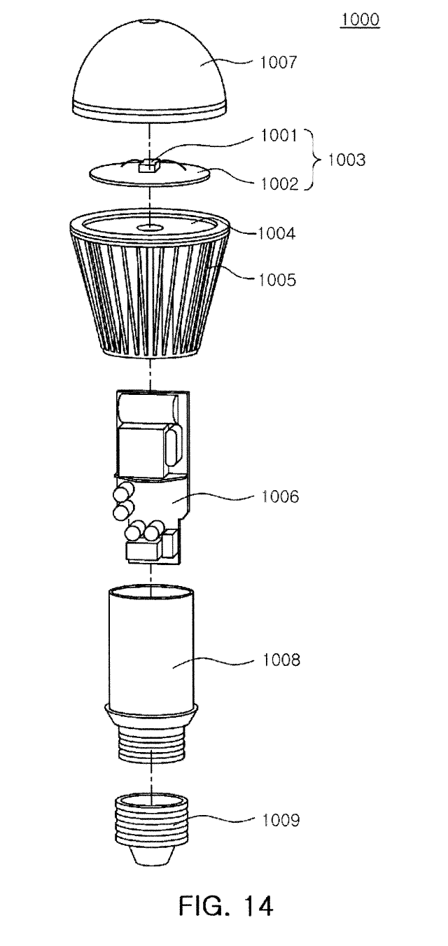

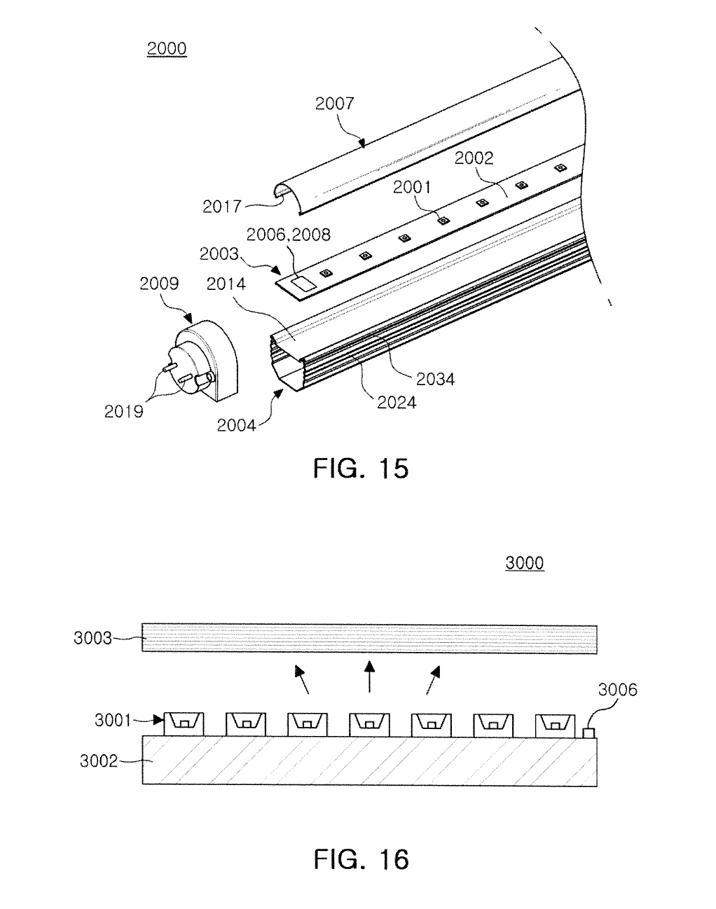

FIGS. 14 and 15 are exploded perspective views illustrating illumination apparatuses 1000 and 2000 according to exemplary embodiments of the present inventive concept by way of example.

The illumination apparatus 1000 may be a bulb-type lamp as illustrated in FIG. 14. The illumination apparatus 1000 may have a shape similar to that of an incandescent lamp so as to be able to be substituted for an incandescent lamp according to the related art and may emit light having light characteristics (a color and a color temperature) similar to those of an incandescent lamp, but the present inventive concept is not limited thereto.

With reference to FIG. 14, the illumination apparatus 1000 may include a light source unit 1003, an LED driver 1006, and an external connection unit 1009. In addition, the illumination apparatus 1000 may further include an outer structure such as an external housing 1005, an internal housing 1008, and a cover unit 1007. The light source unit 1003 may include an LED 1001 and a mounting substrate 1002 on which the LED 1001 is mounted. Although the exemplary embodiment of the present inventive concept illustrates the case in which a single LED 1001 is mounted on the mounting substrate 1002, by way of example, a plurality of LEDs may be mounted on the mounting substrate as needed.

In addition, in the case of the illumination apparatus 1000, the light source unit 1003 may include the external housing 1005 serving as a heat radiating portion, and the external housing 1005 may include a heat radiating plate 1004 directly contacting the light source unit 1003 to improve a heat radiation effect. Further, the illumination apparatus 1000 may include the cover unit 1007 installed on the light source unit 1003 and having a convex lens shape. The LED driver 1006 may be installed in the internal housing 1008 so as to receive power from the external connection unit 1009 having a structure such as a socket structure. In addition, the LED driver 1006 may convert the received power into a current source suitable for driving the LED 1001 of the light source unit 1003 to then be supplied. For example, the LED driver 1006 may include an LED driving unit and a controller as described above with reference to the foregoing exemplary embodiment of the present inventive concept.

The illumination apparatus 2000 may be a bar-type lamp as illustrated in FIG. 15. The illumination apparatus 2000 may be a bar-type lamp. The illumination apparatus 2000 may have a shape similar to that of an incandescent lamp so as to replace an incandescent lamp according to the related art and may emit light having light characteristics similar to those of an incandescent lamp, but the present inventive concept is not limited thereto.

With reference to the exploded perspective view of FIG. 15, the illumination apparatus 2000 according to the exemplary embodiment of the present inventive concept may include a light source unit 2003, a body portion 2004, and a terminal unit 2009, and may further include a cover unit 2007 covering the light source unit 2003.

The light source unit 2003 may include a mounting substrate 2002 and a plurality of LEDs 2001 mounted on the mounting substrate 2002. On the mounting substrate 2002, an LED driving unit 2006 driving the LED 2001 of the light source unit 2003 and a controller 2008 controlling an operation of the LED driving unit.

The body portion 2004 may be provided with the light source unit 2003 installed on and fixed to one surface thereof. The body portion 2004 may include a heat sink, a support structure, and may be framed using a material having excellent thermal conductivity so as to externally radiate heat generated in the light source unit 2003, for example, a metal, but is not limited thereto.

The body portion 2004 may have a lengthwise elongated rod form so as to correspond to a form of the mounting substrate 2002 of the light source unit 2003. In one surface of the body portion on which the light source unit 203 is mounted, a recess 2014 may be formed to receive the light source unit 2003 therein.

The body portion 2004 may include a plurality of radiating fins 2024 protruding from both outer sides of the body portion 2004 so as to radiate heat. In both outer sides of the recess 2014, stop grooves 2034 may be extended in a length direction of the body portion 2004, respectively. A cover unit 2007 to be described later may be coupled to the stop grooves 2034.

Both distal ends of the body portion 2004 in the length direction thereof may be open, such that the body portion 2004 may have a pipe shaped hollow structure in which both distal ends are open. Although the exemplary embodiment of the present inventive concept provides the example in which distal ends of the body portion 2004 are both open, the present inventive concept is not limited thereto. For example, only one of the both distal ends of the body portion 2004 may be open.

The terminal unit 2009 may be provided with at least one open side of both distal ends of the body portion 2004 in a length direction thereof so as to supply power to the light source unit 2003. Although the exemplary embodiment of the present inventive concept provides the example in which the distal ends of the body portion 2004 are both open such that the terminal units 2009 are provided with both distal ends of the body portion 2004, respectively. However, the present inventive concept is not limited thereto. For example, in a structure in which only one side is open, the terminal unit 2009 may only be provided with one open side of both distal ends.

The terminal units 2009 may be coupled to both open distal ends of the body portion 2004, respectively, to cover the both open distal ends. The terminal unit 2009 may include an electrode pin 2019 protruding externally.

The cover unit 2007 may be coupled to the body portion 2004 to cover the light source unit 2003. The cover unit 2007 may be formed using a material allowing for penetration of light therethrough.

The cover unit 2007 may have a hemispherically curved surface so as to uniformly irradiate light externally. On a bottom surface of the cover unit 2007 coupled to the body portion 2004, a protrusion 2017 fitted to the stop groove 2034 of the body portion 2004 may be formed in a length direction of the cover unit 2007.

Although the exemplary embodiment of the present inventive concept illustrates the case that the cover unit 2007 has a hemispherical structure, the present inventive concept is not limited thereto. For example, the cover unit 2007 may have a planar quadrangular shaped structure or other polygonal shaped structures. Such a form of the cover unit 2007 may be variously changed depending on a design of illumination emitting light.

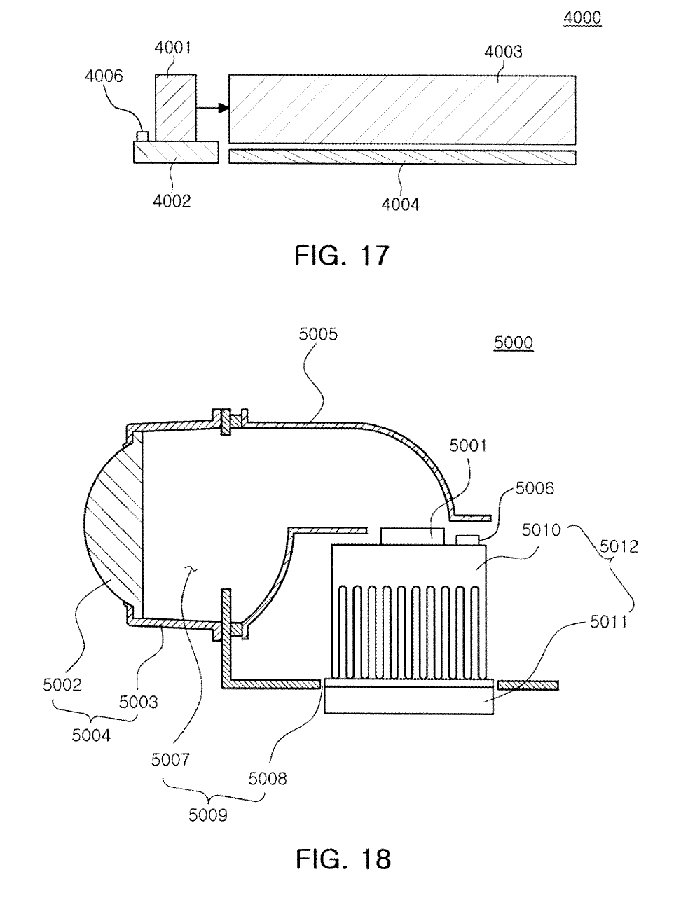

FIGS. 16 and 17 illustrate examples in which an illumination apparatus according to an exemplary embodiment of the present inventive concept is applied to a backlight unit.

With reference to FIG. 16, a backlight unit 3000 may include a light source unit 3001 including LEDs installed on a mounting substrate 3002, and one or more optical sheets 3003 disposed thereabove.

Unlike the case of the backlight unit 3000 that the light source unit 3001 emits light toward an upper part in which a liquid crystal display is disposed with reference to FIG. 16, in the case of a backlight unit 4000 in another example with reference to FIG. 17, a light source unit 4001 mounted on a mounting substrate 4002 emits light laterally and the emitted light may be incident onto a light guide plate 4003 to switch the light into the form of a surface light source. Light passing through the light guide plate 4003 may be emitted upwardly, and in order to improve light extraction efficiency, a reflective layer 4004 may be disposed below the light guide plate 4003. The light source unit 4001 may use a light emitting apparatus having the structure described above according to the foregoing exemplary embodiments of the present inventive concept or a structure similar thereto.

Backlight units 3000 and 4000 of FIGS. 15 and 16 may include an LED driver 3006 and an LED driver 4006 providing driving power to the light source units 3001 and 4001, respectively. The LED drivers 3006 and 4006 may respectively include an LED driving unit and a controller as described above according to the foregoing exemplary embodiments of the present inventive concept.

FIG. 18 illustrates an example in which an illumination apparatus according to an exemplary embodiment of the present inventive concept is applied to vehicle headlights. With reference to FIG. 18, a headlamp 5000 for vehicle lighting or the like may include a light source unit 5001, a reflective unit 5005 and a lens cover unit 5004, and the lens cover unit 5004 may include a hollow guide 5003 and a lens 5002. Further, the headlamp 5000 may further include a heat radiating unit 5012 discharging heat generated in the light source unit 5001 to the outside. The heat radiating unit 5012 may include a heat sink 5010 and a cooling fan 5011 to perform effective heat emission. In addition, the headlamp 5000 may further include a housing 5009 fixing and supporting the heat radiating unit 5012 and the reflective unit 5005, and the housing 5009 may include a central hole 5008 for allowing the heat radiating unit 5012 to be coupled to one surface thereof. Further, the housing 5009 may include a front hole 5007 in the other surface integrally connected to the one surface to then be bent in a direction orthogonal thereto, through which the reflective unit 5005 is fixed to be disposed over the light source unit 5001. Whereby, the front side thereof is open by the reflective unit 5005, and the reflective unit 5005 is fixed to the housing 5009 such that the open front side corresponds to the front hole 5007, whereby light reflected through the reflective unit 5005 may pass through the front hole 5007 to be then emitted externally. The light source unit 5001 may include at least one LED.

In the exemplary embodiment of the present inventive concept, the headlamp may include an LED driver 5006 for driving the light source unit 5001. The LED driver 5006 may include an LED driving unit and a controller as described above according to the foregoing exemplary embodiments of the present inventive concept.

According to an exemplary embodiment of the present inventive concept, a heating problem may be reduced such that precise current detection and control may be performed and an LED driver useful for miniaturization of products may be obtained.

According to an exemplary embodiment of the present inventive concept, an illumination apparatus including the LED driver may be provided.

While exemplary embodiments of the present inventive concept have been shown and described above, it will be apparent to those skilled in the art that modifications and variations could be made without departing from the spirit and scope of the present inventive concept as defined by the appended claims.

What is claimed is:

1. A light emitting device (LED) driver comprising:
an LED driving unit including a substrate and a driving circuit provided with the substrate and including at least one detecting resistor; and
a controller configured to control an operation of the LED driving unit, based on a voltage detected by the at least one detecting resistor,
wherein the at least one detecting resistor includes first and second conductive wire patterns disposed on a first surface of the substrate and a second surface opposing the first surface, respectively, and at least one conductive via electrically connecting the first and second conductive wire patterns.

2. The LED driver of claim 1, wherein the first and second conductive wire patterns, and the at least one conductive via are formed using a material having a specific resistance value of 0.03 Ω·mm²/m or lower at 20° C.

3. The LED driver of claim 2, wherein the conductive via is formed using at least one of aluminum (Al), copper (Cu), gold (Au), silver (Ag), or alloys thereof.

4. The LED driver of claim 1, wherein the first and second conductive wire patterns comprise a plurality of first and second conductive wire patterns and the conductive via comprises a plurality of conductive vias.

5. The LED driver of claim 4, wherein the plurality of conductive vias are respectively connected to the first conductive wire pattern disposed on the first surface, and connected to the second conductive wire pattern disposed on the second surface.

6. The LED driver of claim 4, wherein at least one of the plurality of conductive vias is connected to two or more first conductive wire patterns on the first surface.

7. The LED driver of claim 4, wherein the plurality of conductive vias are arranged in an array including rows and columns.

8. The LED driver of claim 4, wherein intervals between the plurality of conductive vias are substantially similar to one another.

9. The LED driver of claim 4, wherein at least portions of intervals between the plurality of conductive vias are different from one another.

10. The LED driver of claim 4, wherein the plurality of conductive vias include two or more conductive vias having different cross sectional areas.

11. The LED driver of claim 1, wherein the LED driving unit further comprises a circuit pattern provided with the substrate and electrically connecting circuit devices included in the driving circuit to one another.

12. The LED driver of claim 11, wherein the circuit pattern comprises an internal circuit pattern disposed in an internal portion of the substrate.

13. The LED driver of claim 1, wherein the at least one detecting resistor further comprises a third conductive wire pattern disposed in an internal portion of the substrate and at least one internal conducive via electrically connecting the third conductive wire pattern to at least one of the first and second conductive wire patterns.

14. The LED driver of claim 1, wherein the driving circuit further comprises a direct current (DC) to DC converter having a switching device, and the controller is configured to control a duty cycle of the switching device.

15. An illumination apparatus comprising:
a light source unit including at least one LED;
an LED driving unit including a substrate and a driving circuit provided with the substrate and including at least one detecting resistor, and providing driving power to the at least one LED; and
a controller configured to control an operation of the LED driving unit, based on a voltage detected by the at least one detecting resistor,
wherein the at least one detecting resistor includes first and second conductive wire patterns disposed on a first surface of the substrate and a second surface opposing the first surface, respectively, and at least one conductive via electrically connecting the first and second conductive wire patterns.

16. An illumination apparatus comprising:
a light source unit including at least one LED;
an LED driving unit configured for providing driving power to the at least one LED, the LED driving unit including a substrate and a driving circuit provided in the substrate and including an array of detecting resistors; and
a controller configured to control an operation of the LED driving unit, based on a voltage detected by the array of detecting resistors,
wherein the array of detecting resistors includes a plurality vias passing through the substrate, and a first conductive wire pattern and a second conductive pattern disposed on a top surface and a bottom surface of the substrate and electrically connecting the plurality of vias.

17. The illumination apparatus of claim 16, wherein the substrate includes a wiring layer between the top surface and the bottom surface of the substrate, the wiring layer having a third conductive wire pattern.

18. The illumination apparatus of claim 17, wherein the array of detecting resistors further includes an internal via disposed between the wiring layer and either of the bottom surface and the top surface, and the third conductive pattern connects the internal via with the plurality of vias.

19. The illumination apparatus of claim 16, wherein the plurality of vias have different widths from one another.

20. The illumination apparatus of claim 16, wherein the plurality of vias have the same width.
